(19) United States
(12) Patent Application Publication
(10) Pub. No.: US 2006/0057905 A1
(43) Pub. Date: Mar. 16, 2006

(54) Electrical connection part for a die delivering filaments, especially glass filaments

(75) Inventors: Newell D McGill, Wichita Falls, TX (US); Jean-Pierre Renaudin, St-Sulpice (FR); Marc Mounier, Le Touvet (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Saint-Gobain Vetrotex France S.A., Chambery (FR)

(21) Appl. No.: 10/542,655

(22) PCT Filed: Jan. 14, 2004
(86) PCT No.: PCT/FR04/00055

§ 371 Date: Jul. 19, 2005

(30) Foreign Application Priority Data
Jan. 22, 2003 (FR) 03/00813

(51) Int. Cl. H01R 13/02

(52) U.S. Cl. 439/886

(57) ABSTRACT

An electrical connection part for a fiberizing installation for delivering filaments, such as glass filaments, the part being made of an electrically conducting material and having at least one contact surface. The at least one contact surface is coated with gold.

The invention relates to a fiberizing installation delivering continuous filaments, for example glass filaments, and more particularly to an electrical connection part via which one of the components of the fiberizing installation is supplied with current for the purpose of heating it.

Conventionally, a fiberizing installation comprises a glass flow block, which receives molten glass coming from a feeder connected to the furnace in which the glass is melted, a bushing block, and a bushing. The bushing is provided at the bottom with a plate provided with a multitude of holes from which the molten glass flows, to be drawn into a multiplicity of filaments.

These filaments, the diameter of which may vary from 5 to 33 μm, are collected into at least one sheet that converges on an assembling drive in order to form at least one strand and, for example, to be wound up. Depending on its use, the strand may also be chopped (to form chopped strands) or thrown onto a belt (to form continuous strand mats).

The products obtained are used mainly in various reinforcing applications.

The bushing is manufactured from an alloy of platinum and rhodium, which materials are electrically conducting and resistant over time to very high temperatures. This bushing is heated by the Joule effect (resistance heating) so as to maintain, at a certain temperature, around 1100 to 1400° C., the glass that it contains so that it remains in the molten state so as to be drawn from the holes in the bottom of the bushing. The bushing is heated using an electrical transformer by the connection of two terminals, each located on each of the opposed ends of the bushing, to electrical connection elements external to the bushing.

The terminals of the bushing are attached by welding them to the side walls of the bushing. They project so as to be connected to the external connection elements.

These external connection elements or external electrical connection parts are each in the form of a jaw made of electrically conducting material that grips, by its two flanges, a terminal of the bushing, the jaw being connected to a busbar that is connected to the electrical transformer. The connection between the busbar and the jaw is provided by simple contact between one portion of the jaw against the busbar, the latter being maintained at the desired height by any suitable system for fastening onto a fixed element on the outside of the bushing.

To obtain better electrical conduction between a jaw and the connection busbar, these elements are advantageously made of electrolytic copper. A grease suitable for electrical conduction is deposited between the two contact faces of the jaw and of the busbar in order to allow slippage between them. This is because it is necessary for the jaw to be able to move vertically by sliding over the busbar, in order to increase or reduce the contact area between the jaw and the terminal to which it is associated, so as to adjust the amount of current dissipated in the bottom of the bushing and thus ensure its thermal equilibrium.

However, over time and as a result of these successive displacements, the grease may become inhomogeneous, thus creating small cavities devoid of grease that may cause electric arcs between the busbar and the jaw owing to the high current, of around 3000 A, that flows through them. Over the course of time, these electric arcs cause carbonation of the elements, which adversely affects the flow of current and erodes the elements, requiring them to be changed.

It is an object of the invention to avoid this problem.

According to the invention, the electrical connection part, being made of an electrically conducting material and having at least one contact surface, is characterized in that at least the contact surface is coated with gold.

Advantageously, the part is entirely coated with gold. The gold has a purity of at least 97%.

Preferably, the gold is somewhat doped, with cobalt or nickel.

According to one feature, the contact face or faces of the electrical connection part have a hardness of at least 80 HV.

According to another feature, the material of the electrical connection part is made of copper or aluminum.

The invention also relates to a connection device for a fiberizing installation, which comprises the electrical connection part of the invention and a second part, for supply and connection, also made of an electrically conducting material such as copper or aluminum, the two parts cooperating by friction over two respective contact surfaces in order to ensure electrical connection between them, it being possible for the contact surface of the supply and connection part to be covered with silver, tin, zinc or gold. However, it has been observed, surprisingly, that it is unnecessary to coat, in particular with gold, the two parts in mutual contact in order to solve the problem of the invention. Gold must be deposited, above all, on the electrical connection part.

Although the addition of gold substantially increases the cost, this solution does ensure longevity of the electrical connection part, and therefore of the connection device, which means that they do not have to be changed and a return on the investment is eventually seen in the operating cost of the dye. Furthermore, this solution ensures that the contact resistance, and hence the heating of the bushing, remains steady.

Finally, the invention relates to a fiberizing installation that includes a bushing from which the filaments are drawn and heated by the abovementioned electrical connection device.

The electrical connection part for this fiberizing installation consists of a jaw mechanically connected to a terminal of the bushing, the jaw being made of copper and coated on at least its contact surface with gold, and the other part, for supply and connection, of said connection device consists of a stationary part made of copper and maintained at a height for cooperating via its contact surface with the contact surface of the connection part.

Preferably, the bushing of the fiberizing installation is provided with at least two electrical connection terminals that are placed on each of the ends of the bushing.

Advantageously, the stationary supply and connection part has a geometry suitable for bringing into contact with its electrical contact surface several contact surfaces of a plurality of respective jaws, each jaw being electrically and mechanically connected to one of the multiple connection terminals respectively of one end of the bushing.

The invention will now be described in greater detail with regard to the appended drawings, in which:

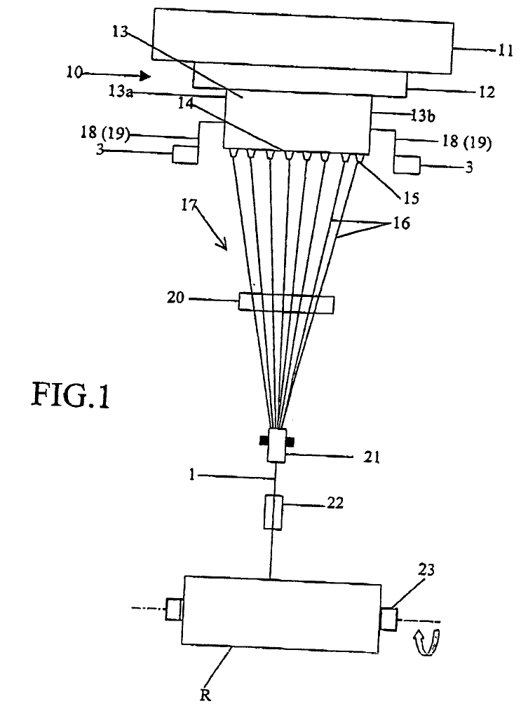

FIG. 1 diagrammatically illustrates a side view of a fiberizing installation, together with the manufactured product;

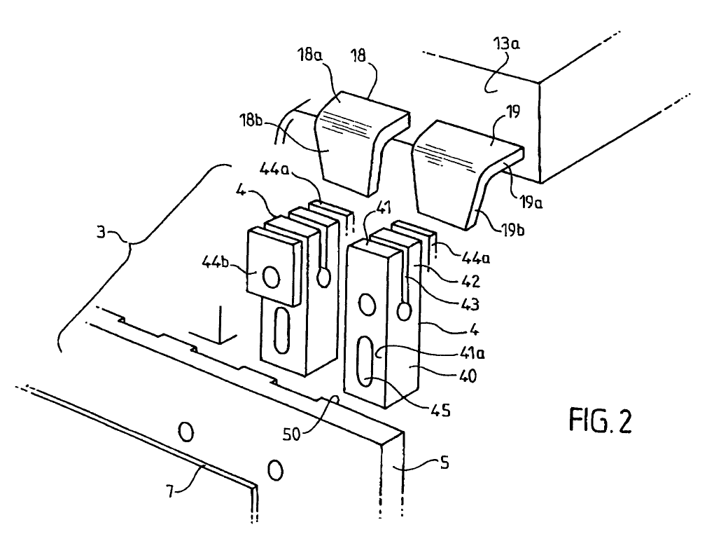

FIG. 2 is an exploded perspective view of one portion of the bushing with its terminals and of an electrical connection device for said terminals;

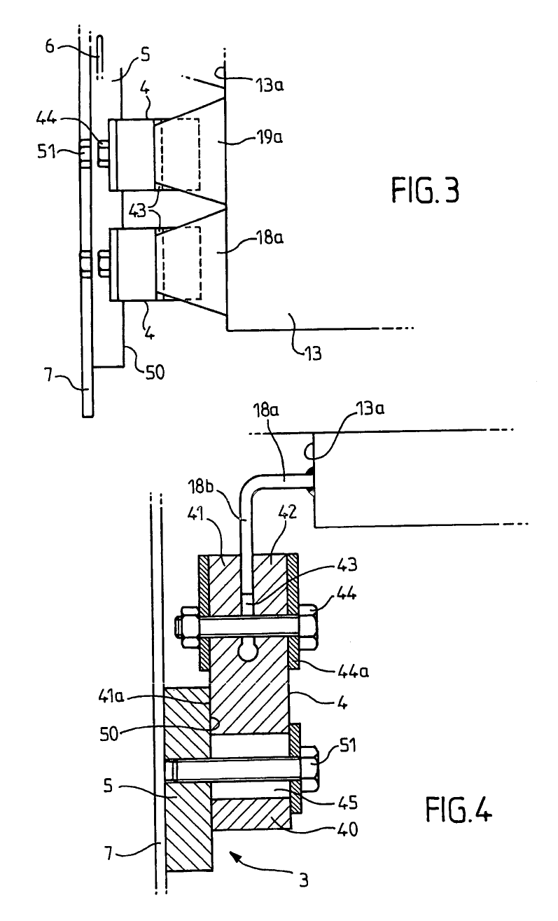

FIG. 3 shows a top view of the elements of FIG. 2; and

FIG. 4 is a sectional view of the elements of FIG. 3.

FIG. 1 shows diagrammatically a fiberizing installation 10 which includes, in the conventional manner, a glass flow block 11, a bushing block 12 and a bushing 13.

The bushing 13 is fitted at the bottom with a plate 14 provided with a multitude of holes 15, drilled in studs, from which the molten glass flows before being drawn into a multiplicity of filaments 16. In recent years, the number of holes has approached and even exceeded 4000.

The filaments are collected into a single sheet 17, which comes into contact with a coating device 20 for coating each filament with a size of the aqueous or anhydrous type. The device 20 may consist of a tank permanently supplied with a sizing solution and with a rotating roll, the lower portion of which is constantly immersed in the solution. This roll is permanently covered with a film of size, which is taken up by the filaments 16 as they slide over its surface.

The sheet 17 then converges on an assembling device 21, where the various filaments are joined together to create a glass fiber strand 1. The assembling device 21 may be formed by a simple grooved pulley or by a plate provided with a notch.

The strand 1 leaving the assembling device 21 enters a strand guide 22, before being wound onto a support 23 whose axis is horizontal, compared with the vertical arrival of the strand into the strand guide. The strand is thus wound, coming directly from the bushing, to form a roving R.

In order for the molten glass delivered to the bushing 13 to remain at a sufficient melt temperature suitable for it to flow through the holes 15 and to be suitably drawn, this bushing is kept heated.

Advantageously, this bushing is made of a platinum-rhodium alloy, which ensures good thermal conductivity, mechanical strength over time at high temperatures, and good electrical conductivity throughout its body, and at its terminals with an electrical connection device 3.

To optimize the electrical power distribution supplied to the bushing and, as will be seen later, to further reduce the risk of electrical connection device deteriorating, each end 13a, 13b of the bushing is provided with at least one terminal, and preferably with two terminals 18, 19.

FIGS. 2 and 3 illustrate the electrical connection parts or jaws 4 that electrically connect a supply and connection part 5 to the terminals 18, 19 on the side 13a, and similarly, but not illustrated, on the opposite side 13b, of the bushing. The supply and connection part 5 and the jaw or jaws 4 constitute the connection device 3 associated with one of the ends of the bushing provided with its terminal or preferably its terminals.

The two terminals 18 and 19 are made of the same material as the bushing 13 and are attached by being welded to each of the ends 13a, 13b.

They are in the form of an L; one of the flanges 18a (19a) is fastened via its end to the end 13a of the bushing, whereas the other flange 18b (19b) perpendicular to the flange 18a and directed parallel to the end toward the lower part of the bushing is connected to the jaw 4.

The connection device 3 therefore comprises at least the jaw 4 to be connected to the flange 18b (19b) of a connection terminal, and the supply and connection part 5 connected to the jaw 4 and to an electrical transformer (not illustrated) via electrical conductors 6.

The jaw 4 is in the form of a U that has a web 40 and two flanges 41, 42 substantially facing the web and perpendicular thereto so as to form a groove 43. In the connection position, the flange 18b (19b) is housed in the groove 43, and a clamp bolt 44, which passes through the flanges 41, 42 of the jaw, ensures, when tightened, that the jaw is in electrical contact with and mechanically retained on the terminal. Two clamp plates 44a, 44b are advantageously associated with the clamp bolt 44.

The supply and connection part 5 is a busbar fixed to an element 7 of the bushing surround at a height suitable for it to face at least one jaw. This part is connected to the electrical current feed conductors 6. It is made of electrolytic copper in order to provide the best electrical conduction of the current to the jaw, which is connected to said part by simple contact.

The part 5 has a connection face or contact surface 50 against which the external face 41a of the flange 41 of the jaw 40 is pressed, which face 50 constitutes the surface for electrical contact of the jaw with the part 5.

The jaw 4 is fixed to the part 5 by clamping means 51 that pass through a slot 45 in the web 40 of the jaw and are housed in a tapped hole in the part.

As was said above, it may be preferable to have several connection terminals, at least two terminals 18 and 19, on the same end of the bushing. For this reason, the part 5 is advantageously in the form of a busbar (FIGS. 2 and 3) and extends along the length of the side wall 13a of the bushing in order to make it easier to connect the jaws 4 to a single element. Thus, whatever the number of jaws used, the jaws being connected to the plurality of terminals at the bushing, a single part 5 is needed to connect all the jaws 40.

According to the invention, the contact surface 41a of a jaw is coated with a film of gold having a purity greater than 97%, with a thickness of about 5 μm, so as to prevent carbonizing and thus protect the copper from erosion. Preferably, the gold is doped, for example with cobalt or with nickel, so as to harden the contact face. The surface of a gold-coated jaw has a hardness of 80 to 90 HV, the same jaw surface coated with nickel-doped gold has a hardness of 140 to 160 HV, and if the gold is cobalt-doped the hardness is 150 to 170 HV.

This gold coating against at least the contact surface 41a is enough to solve the drawbacks of the prior art. Advantageously, the entire jaw, and consequently the surfaces for contact with a terminal, will be coated with gold, preferably cobalt-doped gold, in order to also protect the copper from corrosion due to the particularly aggressive environment to which the jaw is subjected.

However, for the purpose of providing additional corrosion protection, the copper supply and connection part 5 is covered on its faces exposed to the ambient air, and preferably at least on its electrical contact surface 50, with a coating of the silver, tin, zinc or gold type.

1-15. (canceled)

16. An electrical connection part for a fiberizing installation for delivering filaments, wherein the connection part is made of an electrically conducting material and having at least one contact surface, wherein the at least one contact surface is coated with gold.

17. The electrical connection part as claimed in claim 16, wherein the connection part is entirely coated with gold.

18. The electrical connection part as claimed in claim 16, wherein a thickness of the gold is around 5 μm.

19. The electrical connection part as claimed in claim 16, wherein the gold has a purity of at least 97%.

20. The electrical connection part as claimed in claim 16, wherein the gold is doped.

21. The electrical connection part as claimed in claim 20, wherein the gold is doped with cobalt or nickel.

22. The electrical connection part as claimed in claim 16, wherein the at least one contact surface has a hardness of at least 80 HV.

23. The electrical connection part as claimed in claim 16, wherein the electrically conducting material of the connection part is copper or aluminum.

24. An electrical connection device for a fiberizing installation for delivering filaments, comprising:
the electrical connection part as claimed in claim 16; and
a supply and connection part, also made of an electrically conducting material, the electrical connection part and supply and connection part cooperating by friction over two respective contact surfaces to ensure electrical connection between them.

25. The device as claimed in claim 24, wherein the supply and connection part is entirely made of copper or aluminum.

26. The device as claimed in claim 24, wherein the contact surface of the supply and connection part is covered with silver, tin, zinc, or gold.

27. A fiberizing installation for delivering filaments, comprising:
a bushing from which the filaments are drawn, the bushing being heated by an electrical connection device as claimed in claim 24.

28. The fiberizing installation as claimed in claim 27, wherein the electrical connection part includes a jaw mechanically connected to a terminal of the bushing, wherein the jaw is made of copper and coated on at least its contact surface with gold, and the supply and connection part includes a stationary part made of copper or aluminum and maintained at a height for cooperating via its contact surface with the contact surface of the connection part.

29. The fiberizing installation as claimed in claim 28, further comprising a bushing provided with at least two electrical connection terminals that are placed on each of the ends of the bushing.

30. The fiberizing installation as claimed in claim 29, wherein the stationary supply and connection part has a geometry configured to bring into contact with its electrical contact surface plural contact surfaces of a plurality of respective jaws, each jaw being electrically and mechanically connected to one of the multiple connection terminals respectively of one end of the bushing.
